(19) United States
(12) Patent Application Publication
(10) Pub. No.: US 2018/0306890 A1
(43) Pub. Date: Oct. 25, 2018

(54) SYSTEM AND METHOD TO LOCATE AND IDENTIFY SOUND SOURCES IN A NOISY ENVIRONMENT

(71) Applicant: HORNET INDUSTRIES, LLC, Crystal River, FL (US)

(72) Inventors: Robert H. VATCHER, Crystal Lake, FL (US); Bradley C. ALLEN, Stansbury Park, UT (US)

(73) Assignee: HORNET INDUSTRIES, LLC, Crystal River, FL (US)

(21) Appl. No.: 15/771,569

(22) PCT Filed: Oct. 27, 2016
(86) PCT No.: PCT/US2016/058982

§ 371 Date: Apr. 27, 2018

Related U.S. Application Data
(60) Provisional application No. 62/248,524, filed on Oct. 30, 2015.

(51) Int. Cl. G01S 3/86; H04R 3/00; H04R 29/00; G01S 3/808

(52) U.S. Cl. CPC G01S 3/86; G01S 3/8083; H04R 29/008; H04R 3/005

(57) ABSTRACT

A system comprises at least three microphones for generating audio signals representing a sound generated by a sound source, each microphone having a respective identifier (ID), a memory, and a processor. The processor is configured for: storing records in the memory to be referenced using indexes, the indexes based on a time stamp when the audio signals are generated and frequency components of the audio signals, each record containing the respective ID of one of the at least three microphones and a time when the sound is first detected by the microphone corresponding to the ID; matching indexes of records from the memory corresponding to the sound for each of the at least three microphones; and computing a location of the sound source based on the respective arrival times of the sound stored in the records having matching indices by synthetic aperture passive lateration

This application claims the benefit of U.S. Provisional Patent Application No. 62/248,524, filed Oct. 30, 2015, which is incorporated herein by reference in its entirety.

### FIELD

This disclosure relates to sound localization apparatus and methods.

### BACKGROUND

Noise pollution is ubiquitous in modern cities. For example, more than one million automotive vehicles move through the streets of New York City each day. These vehicles emit noise from their engines, mufflers, horns, brakes, tires and audio equipment. Some municipalities wish to regulate such noise pollution and restrict the volume and/or circumstances in which motor vehicles can emit noise.

To permit enforcement of noise ordinances, it is desirable to identify the source of a noise.

### SUMMARY

In some embodiments, a system comprises at least three microphones for generating audio signals representing a sound generated by a sound source, each microphone having a respective identifier (ID), a memory, and a processor. The processor is configured for: identifying a respective set of strongest frequency components of the audio signals detected by each one of the at least three microphones; generating a respective index from a time stamp indicating when the audio signals are received from each respective one of the at least three microphones and a respective plurality of frequency bands corresponding to the set of strongest frequency components; storing records in the memory to be referenced using the indexes, each record containing the respective ID of one of the at least three microphones and a time when the sound is first detected by the microphone corresponding to the ID; matching indexes of records from the memory corresponding to the sound for each of the at least three microphones; and computing a location of the sound source based on the respective arrival times of the sound stored in the records having matching indices.

In some embodiments, the system is used to perform method of determining a location of a source of a sound.

In some embodiments, a non-transitory machine readable storage medium is encoded with computer program code, such that when the computer program code is executed by a processor, the processor performs the method of determining the location of the source of the sound.

In some embodiments, a system comprises at least three microphones for generating audio signals representing a sound generated by a sound source, each microphone having a respective identifier (ID), a memory, and a processor. The processor is configured for: storing records in the memory to be referenced using indexes, the indexes based on a time stamp when the audio signals are generated and frequency components of the audio signals, each record containing the respective ID of one of the at least three microphones and a time when the sound is first detected by the microphone corresponding to the ID; matching indexes of records from the memory corresponding to the sound for each of the at least three microphones; and computing a location of the sound source based on the respective arrival times of the sound stored in the records having matching indices by synthetic aperture passive lateration (SAPL).

### BRIEF DESCRIPTION OF THE DRAWINGS

FIG. 1A is a block diagram of a system according to some embodiments.

FIG. 1B is a schematic diagram showing relationships among elements in FIG. 1A.

FIG. 2 is a flow chart of a system configuration method for the system of FIG. 1A.

FIG. 3 is a flow chart of a method of using the system of FIG. 1A, according to some embodiments.

FIG. 4 is a flow chart of a method of collecting and time stamping data in the system of FIG. 1A.

FIG. 5 is a diagram showing sample data records for the data collected in FIG. 4.

FIG. 6 is a flow chart of a sound localization method using the system of FIG. 1A.

### DETAILED DESCRIPTION

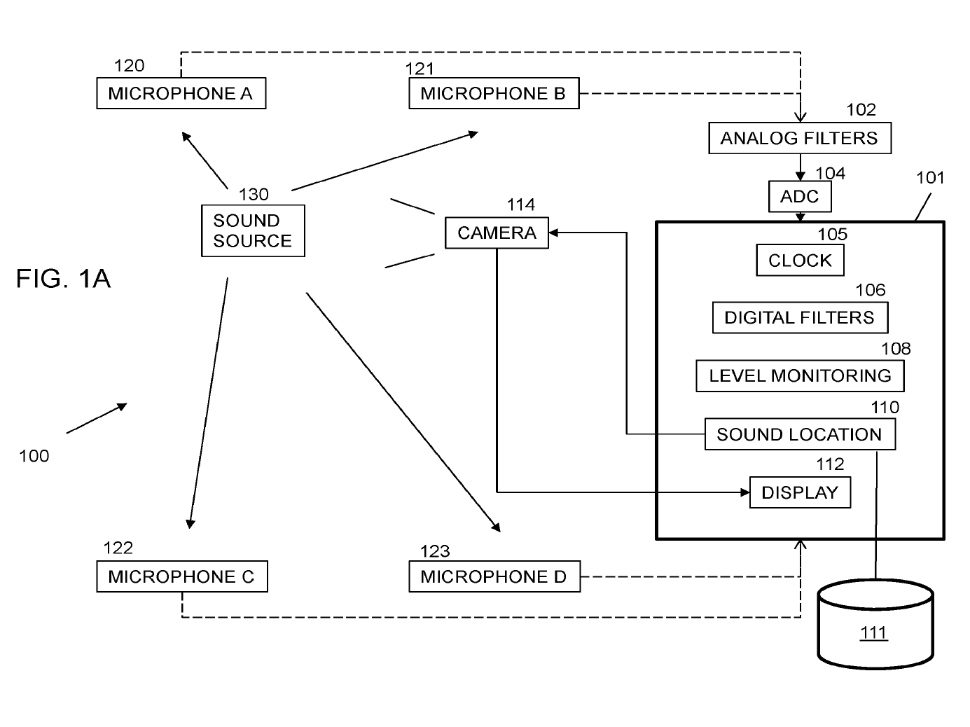

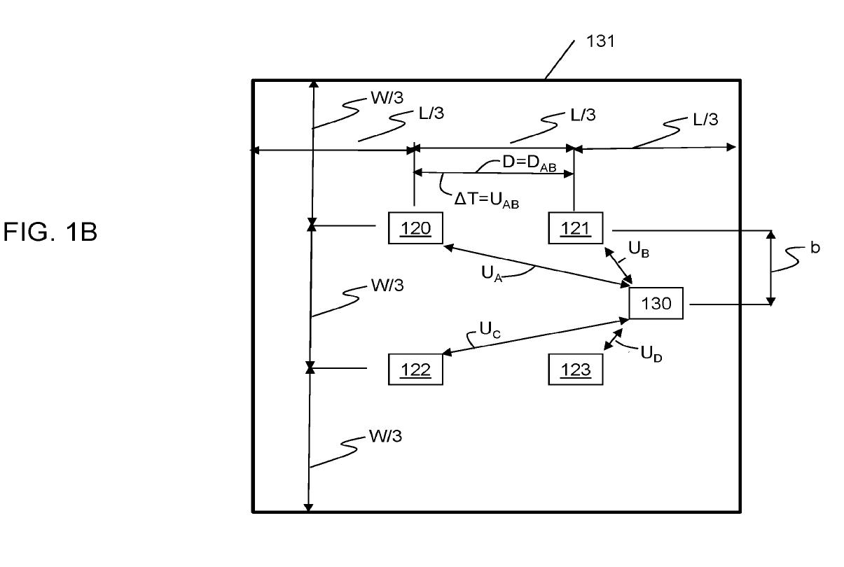

FIG. 1A is a block diagram of a comprehensive near real-time audio/video system 100 for locating, identifying, and correcting noise pollution at its source. In some embodiments, this is accomplished via a network of synchronized microphones 120-123 feeding into a complete system 101 of analog filters 102 and digital filters 106, digital signal processing, and passive sound location 110—all of which can be integrated with video systems 114 to provide a visual correlation of an offending noise source.

Systems according to the principles described below can be used for various sound localization applications, such noise pollution abatement, law enforcement, etc.

In some embodiments, the accuracy of this system is about seven millimeters. Accuracy can be degraded by the relationships of atmospheric attenuation, source loudness vs ambient noise, high winds, and the suddenness of the sound source.

For instance, a car's horn with its steep leading edge and loud burst of sound can be detected with greater accuracy than a sound with a gradual crescendo and low signal to noise ratio.

The system 100 is also highly configurable to fit the specific environment of each installation, whether the system is used in a quieter suburban area with lower ambient noise and occasional boom cars (vehicles containing loud stereo systems that emit low frequency sound, usually with an intense amount of bass) or a busy, big-city street corner with a rich environment of noisy cars and trucks. The system 100 can be configured to fit the needs of each installation's unique circumstances.

When locating the source of any type of sound wave emitter by time difference of arrival (TDOA), be it sound, radio, or light waves, the system identifies when that source was transmitted to the precision of the receivers' sample rate and equals one divided by the number of samples per second—SPS. (e.g. 48,000 sps=21 microseconds of wave travel time accuracy). If the method is used for localization of an radio frequency (RF) or light signal source, a leading edge amplitude trigger is included to determine the beginning of each signal period.

In some embodiments, the system 100 monitors for significant changes in signal strength, with reference to its own internal clock 105, to determine a relative time of broadcast.

Data Acquisition

FIG. 1B is an example of an installation of a system. In some embodiments, the system 100 has an array of three or more (e.g., four) clock-synchronized receivers, such as microphones 120-123, placed at each corner of a rectangular (or near-rectangular) area within a sound collection region 131, that is used for live monitoring of all ambient sounds in the region 131. In FIG. 1B, the sound collection region 131 has a length L and a width W. The microphones 120-123 are placed at corners of an area having length L/3 and width W/3, having the same center as the collection region 131. If each microphone is capable of detecting a sound at a distance ⅔*(L²+W²)^{1/2} from that microphone, then each microphone will be capable of detecting a sound anywhere within the sound collection region 131. Although the system can use microphones arranged in a non-rectangular configuration, the rectangular configuration simplifies computations and reduces processing time.

Put another way, given four microphones, each capable of detecting a sound at a distance D, the system can provide continuous localization within a square area of size 3D×3D.

In another example, the microphones 120-123 are positioned in a square sized so that the amount of time (ΔT) before a sound emitted at the location of microphone 120 is first received by microphone 121 equals U_{AB}. Each microphone is capable of detecting a sound far enough away that the transmission time of that sound is 2U_{AB}. Thus, the sound collection area can be a square of size 3U_{AB}×3U_{AB} (i.e., an end-to-end travel time of sound along each side of the sound collection area is 3U_{AB}).

Some embodiments use time difference of arrival localization routines, and synchronize the timing between individual receivers for system accuracy.

Audio

For audio, some embodiments achieve synchronization by connecting all the microphones to a single unit of multichannel audio Analog to Digital Converters (ADC). In other embodiments, where this isn't practical, multiple ADCs that allow for external clock sources can be chained together through the use of a single master clock source.

Cable lengths for audio implementations (e.g., microphone to ADC cable or clock synchronization), can be different from each other by as much as six kilometers without adversely affecting accuracy in a 48,000 sample rate implementation. (Electromagnetic signals can travel six kilometers in the twenty microsecond interval of audio samples.)

In some embodiments, without dedicated timing cables, receiver clocking can be achieved with the use of GPS satellite based timing systems. For example, GPS based timing may be used, if dedicated timing cables to each receiver would be obstructed by land development or access rights. If GPS timing is used, accuracy is within 20 microseconds for a 48K audio sample rate.

The selection of microphones for this system can vary depending on implementation. For open area audio localization, using wide diaphragm, omnidirectional condenser microphones can provide the ability to pick up ambient noises from all angles. Cardioid microphones can be mounted against a wall or other sound reflective material to minimize echo saturation.

Electromagnetic Spectrum

In embodiments locating the source of electromagnetic waves (radio or light) varying cable lengths and clock timing are precise, as three nanoseconds of timing equals 1 meter of accuracy. Cable length variation has a one-to-one effect (one meter cable equals one meter accuracy)

The outputs of microphones 120-123 are transmitted (via wired or wireless interfaces, not shown) to a processing system 101. In some embodiments, each of the multiple audio streams detected by the respective microphones 120-123 are fed through analog filters 102 to de-emphasize background noises and to emphasize target noises, before the signals are digitally filtered.

Each filtered analog stream is then fed to another digital signal processing system including a analog to digital converter (ADC) 104 that converts the analog audio into individual digital streams. In some embodiments, the digital streams are passed digital filters 106 to further decrease ambient sounds and to increase the signal strength of the target sounds.

In exceptionally noisy environments where non-target background noises could potentially overwhelm the digital signal processor (DSP) within the digital filters, analog band pass filters can be used as means to eliminate background noise before audio reaches the digital filters.

Next, a level monitoring module 108 provides a third stage of filtration that closely monitors the level of ambient noise and watches for the sound volume within any one or more of the streams to reach a configurable level above ambient sound and/or noise as measured in amplitude ratio. To counter the possibility of a random noise spike within the system 100 equipment, subsequent digital samples of the audio stream are checked to ensure this triggered event is more than just random noise within the processing system 101.

In some embodiments, the FFT calculations are processor intensive, so a final Trigger Ratio is used to cancel out unwanted system and environmental noises to prevent superfluous events from wasting processor cycles. These events may include acoustic pops and sudden gusts of wind among other things. By identifying a target sound when multiple samples exceed the trigger threshold while some samples do not exceed the trigger threshold, more unwanted background noises are ignored by the system.

In some embodiments, the adjustable configuration variables include

1. Sample Size: How many samples are used for measurement of the signal level.

2. Mean Value: The rolling average of previous Sample Size of samples.

3. Trigger Threshold: How much stronger than the Mean Value should a jump in sound level be to indicate a new event.

4. Trigger Value: The Mean Value multiplied by the Trigger Threshold.

5. Trigger Ratio: A set of three values (a, b, c), such that, given a sample set containing c consecutive samples, the system considers a sound to be a “legitimate” target signal if the number of samples having a value greater than or equal to the Trigger Value is in the range from a to b. Thus, a and b are the minimum number and maximum number of samples within a sample set having m samples greater than or equal to the Trigger Value for the sample set to be considered a legitimate signal (as opposed to background sound or noise).

The values a, b and c are set by the administrator or user. To increase the sensitivity of the system (i.e., classify more sounds as legitimate signals), a, b and c are selected so that a is closer to zero, b is closer to c, and/or (b-a)/c is larger. To increase the selectivity (i.e., classify more sounds as background or noise), a, b and c are selected so that a is close to b, and (b-a)/c is smaller. If a and be are both close to zero, a large number of samples are considered to represent a high background sound level. If a and b are both near c, then a larger number of samples are considered to be random noise.

### Example

1. Sample Size
Typically 256 or 512, Our example 10

2. Sample Set:

[984,443,780,1124,180,318,1427,426,383,57 . . . Xₙ]

3. Mean

Average(Sample_Set)=612

4. Threshold

Threshold=1.5

5. Trigger Value

Mean*Threshold=918

6. Trigger Ratio

[min max samples]=[3 6 8]

7. Result

[984,443,780,1124,180,318,1427,426]=Valid Event!

8. Summary
In the final result three values (out of the first eight values) are greater than (or equal) to the trigger value

(984,1124,1427)>=918
So, of the first eight samples of the sample set, three are higher than the trigger value. As the trigger ratio uses a minimum of three, and a maximum of six, of the first eight values of the sample set to be greater than 918, the first eight signals represent a valid event. If more than six (i.e., seven or eight) of the first eight signals are greater than the trigger value, then the sample set does not represent a sound event, but is more likely an increase in the background sound level.

The method iterates through the sample stream checking each value to see if it is greater than the Trigger Value. In some embodiments, to speed execution time and conserve processing resources, no other check is performed to determine whether a valid event has been detected until at least one value is greater than the trigger value.

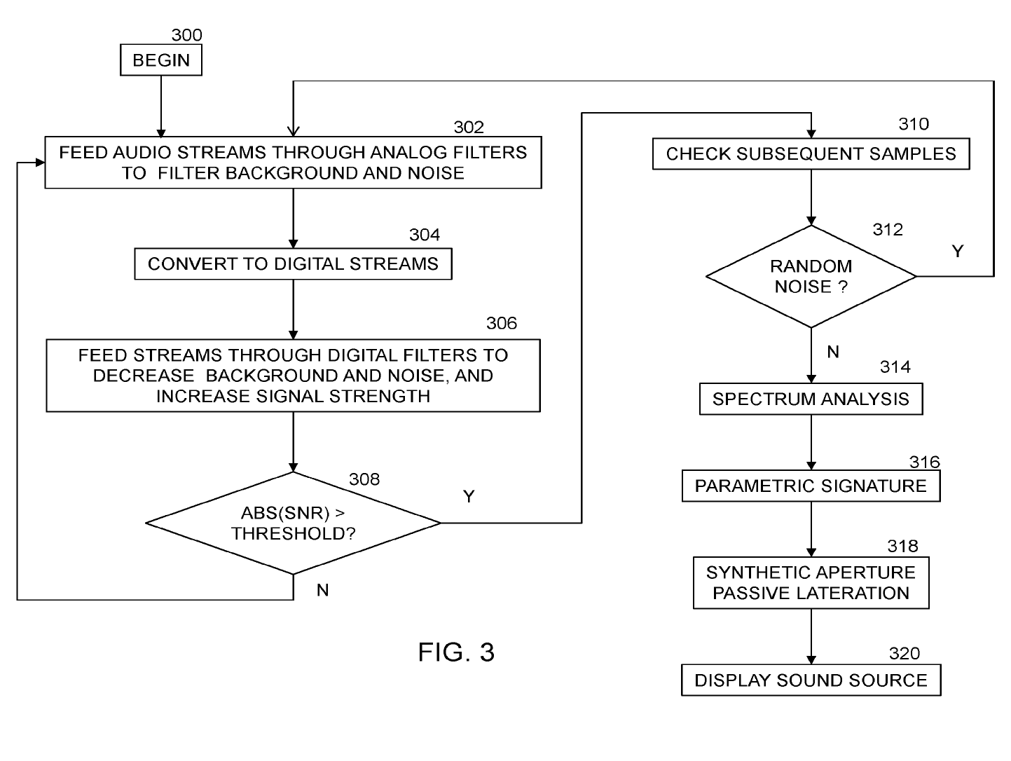

FIG. 3 is a flow chart summarizing a method of sound location using the apparatus of FIG. 1A.

At step 302 the received analog data streams are fed through analog filters to filter background sound and noise.

At step 304, the analog streams are sampled and converted to digital streams.

At step 306, the digital streams are fed through digital filters to decrease background and noise components and increase signal strength.

At step 308, a determination is made whether the amplitude of the signal in each stream is greater than a threshold value. If the amplitude is greater than the threshold, step 410 is performed. If the amplitude is not greater than the threshold, steps 302-308 are repeated.

At step 310, the system checks subsequent samples to confirm that the received signal is not random noise.

At step 312, if the detected sound has the characteristics of noise, steps 302-308 are repeated. If the detected sound does not have the characteristics of noise, step 314 is executed.

At step 314, a spectrum analysis is performed on the streams.

At step 316, a parametric signature is constructed for each received packet.

At step 318, SAPL is performed to determine a location of the sound source.

At step 320, the sound source is imaged by the camera 114 and displayed on the display device 112. In some embodiments, the processor commands an actuating mechanism to point the camera 114 toward the location of the sound source. For example, the processor can calculate an azimuth and an elevation to the actuating mechanism, from the location of the sound source relative to the location of the camera; the processor commands the camera to rotate to that azimuth and elevation.

In other embodiments, the processor identifies the location of the sound source, and the user manually points the camera toward that location. In other embodiments, the processor calculates the location of the sound source and displays left, right, up and/or down arrows to guide the user to aim the camera at the sound source. In some embodiments, the arrows are displayed on devices (e.g., light emitting diodes, LEDs) proximate the camera, for ease of viewing by the user. Embodiments with fixed camera mounts, can use a visual marker overlay to digitally point out the offending noise source.

Spectrum Identification

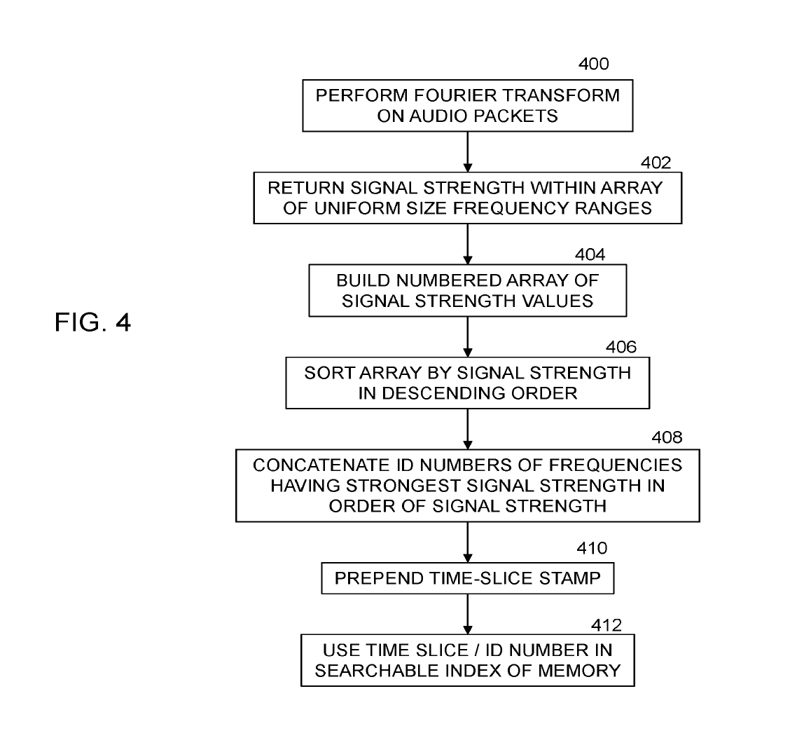

FIG. 4 is a flow chart showing an example of the processing of FIG. 3. At step 400, the spectrum analysis module 414 receives the encapsulated audio packet and performs a Fourier Transform. At step 402, the spectrum analysis module 414 returns the signal strength at incremental frequency ranges. Then at steps 404-410, the transformed signal is converted into a parametric signature of the offending audio source. At step 412, this signature is used as a reference index for storing the receiver's ID and a timestamp 111. This information is stored in an extremely fast and short duration RAM database in a non-transitory, computer readable storage medium 111 for matching against sounds arriving at the other microphones. Each of these events is checked against the database to see if there's a match at the other microphones. When a match is found for four (or more) of the receiving microphones, the stored information is then passed to the location algorithm, referred to herein as “Synthetic Aperture Passive Lateration” (SAPL).

Parametric Signature

The parametric signature is generated by first taking each of the triggered sound samples and performing a Fourier Transform at step 400.

At step 402, the Fourier Transform returns a numbered array of values representing the signal strength of a signal for each audio frequency range.

At step 404, the array of signal strength values is built.

At step 406, the array of signal strength values is then sorted on the signal strength in descending order.

At step 408, the ID numbers of the frequencies having the strongest signal strength are concatenated together as a string, thus providing the frequency portion of the signature.

For example:

An audio recording rate of 44,100 samples per second will have an upper limit of 22,050 Hertz response (one half of the sample rate). If we run a FFT size of 512, it will return the signal strength of the whole frequency range (22,050 Hz) broken out into 511 samples (The breakout is one less than the FFT size). Each sample would represent about 43 Hz of the recordable frequency spectrum.

The sounds heard every day are usually a composite of several frequencies, like chords on a piano or guitar. For The system 100, the strongest of those notes are strung together.

For example, assume that the targeted source has four notes to its sound at 2200 Hz, 3300 Hz, 4400 Hz, and 5500 Hz. Assume their strength order from highest to lowest is 3300 Hz, 5500 Hz, 2200 Hz, and 4400 Hz. The FFT sample will have these numbered, so that 1 is 0-43 Hz; 2 is 44-86 Hz; 3 is 87-120 Hz, etc. In the example; 2200 Hz would be 51; 3300 Hz would be 77; 4400 Hz would be 102; and 5500 Hz would be 128.

Since the array is sorted by strength and the index is used for the reference, the signature could be represented by 77, 128, 51, and 102. Also, to make the signatures consistent 3 digit values (with leading zeroes) can be used. In this example, the values are 077, 128, 051, and 102.

In some embodiments, the user inputs a value that decides how granular the signature will be depending on the target and the environment that is monitored. If the top three tones are desired, they are concatenated into a string. In the example the concatenated string is 077128051.

At step 410, the system pre-pends a time slice stamp to the string. The method mathematically slices the timing system so targets occurring within less than a second of each other can be differentiated by arrival time.

For example, if the time-slice size is 125 milliseconds (with eight slices occurring every second) and the target event occurs at 3 hours 45 minutes and 14.25 seconds after the systems internal epoch, the slice stamp would be equal to

((3*3600)+(45*60)+14.25)*8

The parametric signature module 316 multiplies the sum of the hours, minutes, and seconds by 8 slices per second providing a slice ID of 50,514. In this example, dropping the comma and prepending the time value with a dash to the frequency signature, provides a complete parametric signature of

50514-077128051

This becomes the searchable index in the extremely fast RAM database for finding the matching entries from each microphone 120-123 from the same source across the microphone array. The system 100 also checks the database for similar signatures from the previous time-slice to account for time-slice overlapped events.

Once a complete set of intercepts has been found for a target, that data set is forwarded to the SAPL module 320. At step 412, the SAPL module 320 uses the time slice and ID number in the searchable index of a memory for target localization.

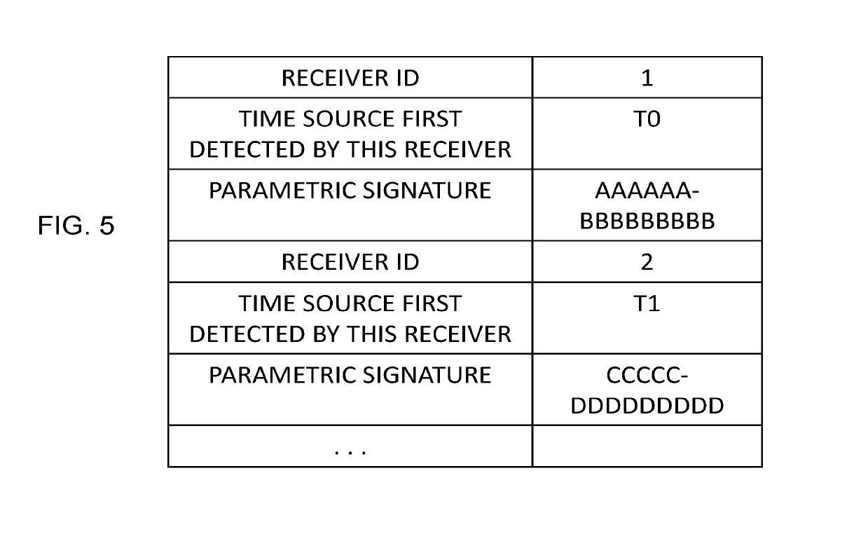

FIG. 5 shows an example of an arrangement for the index. For each sound received by one of the microphones, a respective entry is provided. Each entry has the receiver ID (e.g., 1-4), the time when this sound source was first detected by this receiver, and the parametric signature corresponding to this receiver and time.

Synthetic Aperture Passive Lateration (SAPL)

SAPL can be used instead of Multilateration, and is useful in Time Difference of Arrival calculations where the time of transmission from the sound source is not known. For example, a sound from an unknown sound source at an unknown location is received at four different times by the four microphones 120-123. SAPL can find the location, even though the total transmission delay for the sound to reach each respective microphone is unknown. The microphone outputs indicate arrival time, not total delay.

Nomenclature

D_{AB} Distance (physical) between receivers A and B.

U_{AB} Distance (in time) between receivers A and B.

U_{A . . . D} Units of time marking source reception at A to D

C_{A . . . D} Calculated time from source to receivers

r_{A . . . D} Radius of a circle around receivers A to D

n Number of aperture iterations

R_{S} Radius of the initial Synthetic Aperture

R_{C} Current calculated radius

R_{0 . . . n} Equals R_{S}/2ⁿ

Example layout of Receivers;
C D
A B

TOD Time difference of arrival.

S_{0 . . . n} Source real time of arrival.

Configuration

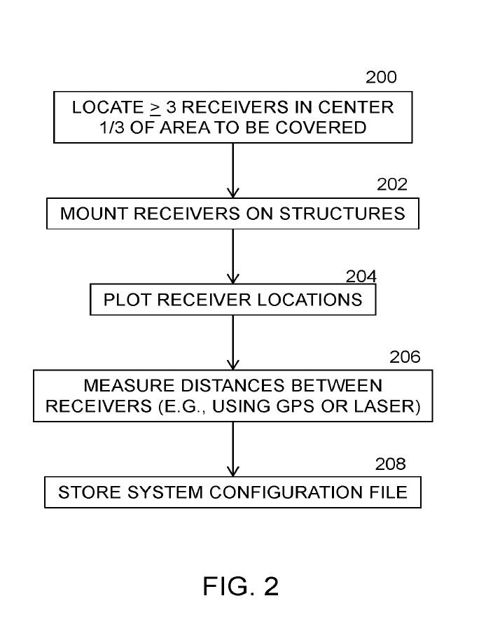

FIG. 2 is a flow chart showing a method for system setup and configuration. The system 100 is intended to be used with four or more receivers (e.g., microphones) 120-123 to permit location in a three-dimensional Cartesian coordinate (X,Y,Z) space, but in other embodiments, three microphones are used to enable location within a two dimensional Cartesian (X, Y) space. In some embodiments, three receivers are set up configured in a right triangle for computation simplicity. In other embodiments, the three receivers can be arranged in a triangle without any right angle.

At step 200, the receivers 120-123 are set up in a distributed pattern (e.g. square, rectangle, circle, etc.) over the middle third of the area 131 to be covered.

At step 202, the receivers 120-123 can be mounted on structures at a height greater than heights of obstructions within the area 131. For example, in an area 131 filled with people, the receivers can be mounted at a height greater than 2 meters (6.5 feet), which is greater than the height of most people. In some embodiments, the receivers 120-123 are mounted on pre-existing structures in the middle of the sound collection area 131.

At step 204, at the time of system installation, the receivers' X, Y, and Z coordinates are measured (e.g., by GPS) and plotted within a Cartesian coordinate system.

At step 206, at the time of system installation, the distances between each respective pair of the receivers 120-123 are measured using GPS and/or laser-distance accuracy.

At step 208, the locations of the receivers 120-123 are stored in a system configuration file, which is read at system startup.

Concepts

Reference is again made to the geometry of FIG. 1B. Each receiver 120-123 has a pairing with each of the other receivers such that a straight line can be drawn between the receivers, and a precise distance can be calculated from the x, y, and z coordinates of the receivers. For this discussion, D_{AB} denotes physical distance (meters or feet) between receivers and U_{AB} denotes time difference (milliseconds or seconds) between emission of a sound at the location of one receiver, and the first reception of that sound at another receiver. Without specifying a unit of measure, these values become almost interchangeable but are still separated for clarity.

The maximum distance L covered by each receiver pair (e.g., 120 and 121) is three times distance between the receiver pair or 3*D_{AB} with the receiver pair marking the center of that distance. With a second pairing of receivers, where the second pair of receivers may include one of the first pair and form a line perpendicular to the first pair (D_{AC}), the total area covered equals the area of a rectangle marked by the two pairs;

3D_{AB}*3D_{AC}

Beyond the maximum distance (based on the specifications for the selected microphones 120-123) it may be difficult to discern how many multiples of D_{AB} the source is from the receivers, so 2D_{AB} represents the furthest distance in each direction (from the opposite receiver in the pairs. So the maximum time of arrival becomes 2U_{AB}.

An arbitrarily located sound source 130 can be located at a respectively different distance D_{A}, D_{B}, D_{C}, D_{D}, (D_{A . . . D}) from the sound source 130. Thus, as shown in FIG. 1B, each receiver 120-123 can first receive the sound at a respectively different time U_{A}, U_{B}, U_{C}, U_{D}, (U_{A . . . D}).

If, for example, U_{B} is less than U_{A}, then S₀ is closer to RB than R_{A}, and the value of U_{A}−U_{B} should always be less than 2U_{AB}; and intercepts of sources U_{A}−U_{B} greater than 2U_{AB} should be discarded as false/inaccurate intercepts.

Computation

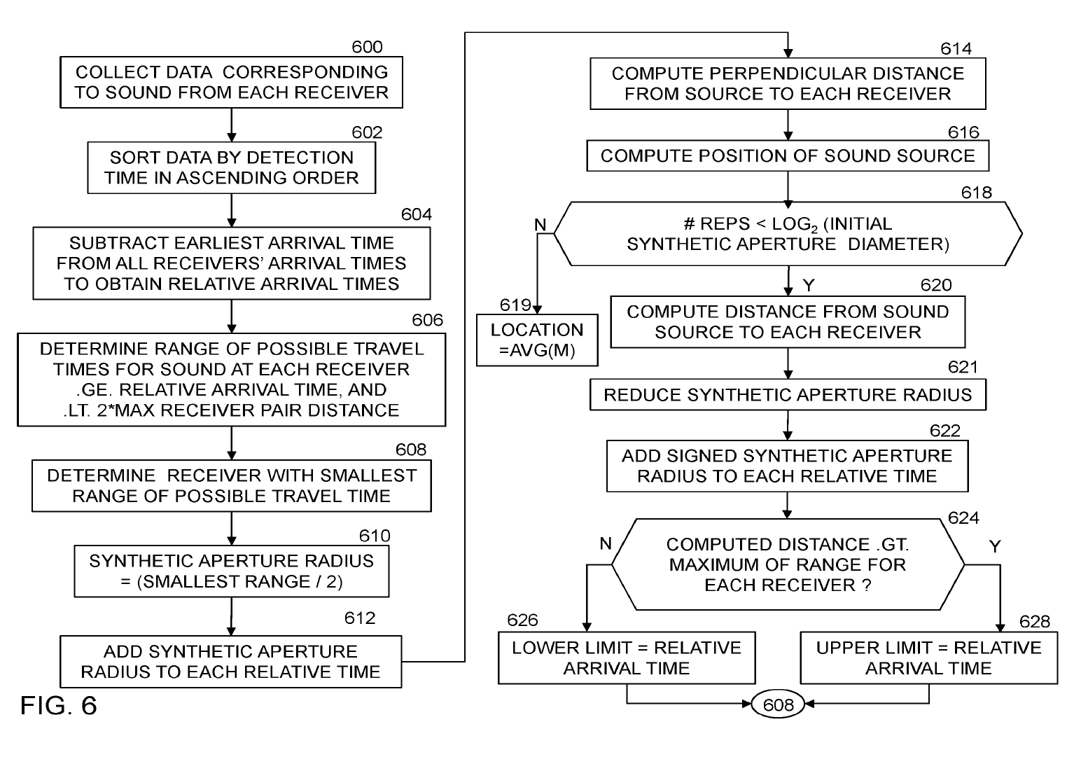

FIG. 6 is a flow chart showing one example of a method for performing SAPL.

At step 600, the system collects data corresponding to the same sound from each receiver 120-123. Using the notations and arrangement mentioned above with respect to FIG. 5, the data set of the new source S₀ includes for each receiver:

The receiver ID (A to D).

The time the source was first detected at the receiver.

The parametric signature, used for logging.

At step 602, the processor sorts these data elements by detection time in ascending order so that the receiver closest to the source will be first, and the receiver farthest away will be last.

At step 604, the processor takes the arrival time of the first receiver and subtracts it from each of the receivers, thus giving us arrival times relative to the first arrival time.

For example, using receivers in a square area of 25×25 feet and 1,126 feet per second as the speed of sound we will place the source, S₀—in feet at X=31, Y=6, and Z=0. The arrival times from the source to the receivers is (in microseconds):

Receiver: A 28,042

Receiver: B 7,535

Receiver: C 32,290

Receiver: D 17,695

Notes for the example:

The processor doesn't actually know these aforementioned times, but use the elapsed system time for the calculations,

The primary unit of measure is the distance sound travels per microsecond and is notated in microseconds.

It is assumed there is no wind and the speed of sound is uniform in all directions.

Sorting by time, and subtracting the lowest value from all values, gives us a difference (Δ) in TOA from the closest receiver, referred to below as the relative arrival time:

Δ_{B} 0

Δ_{D} 10,160

Δ_{A} 20,507

Δ_{C} 24,755

At step 606, the processor determines a respective range of possible travel times for the sound at each receiver. The possible travel time will be greater than or equal to the relative arrival times. Also, based on the discussion of FIG. 1B above, the possible arrival time will be less than or equal to twice the maximum receiver pair distance for each receiver. For example, with the receiver pairs in a square at 25 feet per side, we calculated U_{AB} as 22,202 microseconds with 2U_{AB} (the maximum) being 44,404 microseconds. However, both U_{BC} and U_{AD} are at opposite corners of the square, so they are 35.53 Feet apart giving U_{BC}=31,400, and 2U_{BC}=62,400.

Thus, in this example, the time of the source event is defined by the following inequalities:

20,507<=U_{A}<=44,404

0<=U_{B}<=44,404

24,755<=U_{C}<=62,400

10,160<=U_{D}<=44,404

At step 608, the processor determines which of the four receivers 120-123 has the smallest range of possible travel times. In the example above, the value of U_{B} is added to each of the arrival times, and will provide the true time of the source event for each receiver.

Taking the low and high numbers with the smallest difference (in this case the formula for U_{A}) provides:

44,404−20,507=23,897 microseconds of difference between the possible start time of S₀ and the start time of the relative time measurements.

At step 610, the synthetic aperture radius is computed. As the wind is still, the value 23,897 is uniform for all directions and becomes the maximum diameter of a circle defined as the Synthetic Aperture. One half of this value is the synthetic aperture radius.

At step 612, the processor adds the radius of the aperture (11,948.5 microseconds) to each of the relative times at the receivers e.g.

U_{B} 0+11,948=11,948

U_{D} 10,160+11,948=22,108

U_{A} 20,507+11,948=32,455

U_{C} 24,755+11,948=45,262

Note: the value 11,948.5 is rounded down, as 500 nanoseconds is much smaller than the theoretical resolution.

With these values and the previously established U_{AB} value of 22,202 microseconds between each receiver pair, we now have the three sides of a triangle for each receiver pair and at step 614, the processor can use basic Euclidean Geometry to calculate a position (a, b) in relation to the axis of a receiver pair.

So, using:

$$a = \frac{{U}_{A}^{2} - {U}_{B}^{2} + {U}_{AB}^{2}}{2 {U}_{AB}}$$

returns a distance of 31,607 microseconds from receiver A on a direct line with receiver B.

U_{A} can now be used as the hypotenuse of a right triangle for calculating the distance b perpendicular to the axis of U_{AB}. Thus, continuing the above example, using

b²=U_{A}²−α²

returns 7,370 microseconds perpendicular to the axis of U_{AB}.

At step 616, this information is used to compute a position of the sound source. Since we already know the coordinates of each receiver, we can calculate the position of the results, relative to the U_{AB} receiver pair as x, y plot points.

At step 618, a loop including steps 620-628 is performed a number of times n given by

n=log₂(Initial Synthetic Aperture Diameter)

At step 620, the processor computes the calculated distance (C_{A . . . D}) from this position to each of the other receivers and subtracts those values from U_{A . . . D}.

The difference of these values represents an accuracy (a) of the calculations. However, what is most important at this point, is the sign of the difference of:

s=sign(U_{A . . . D}−C_{A . . . D})

Beginning with

n=0 . . . log₂(R_{S})

At step 621, the processor updates the synthetic aperture radius value. The Calculated Radius R_{C} is the previous R_{C} plus or minus the value of the Starting Radius R_{S} divided by 2̂ iteration count of the binary logarithm, or;

R_{C}=R_{C}+(R_{S}/2ⁿ)*s

At step 622, the processor adds the synthetic aperture radius R_{C} to each relative time.

At step 624, s determines how this sum of the synthetic aperture radius and relative time is used. If U_{A . . . D}−C_{A . . . D} is negative, the computed distance is greater than the maximum of the range for each receiver and step 628 is executed. U_{A . . . D}−C_{A . . . D} is positive, the computed distance is less than the maximum of the range for each receiver, and step 626 is executed.

At step 628, if the result is negative, then the radius of the aperture has overshot the target source and the aperture value of 11,948 microseconds added to the relative times of Δ_{A . . . D} and becomes the new upper limit of the aperture, while the low end stays the same.

At step 626, for a positive result, 11,948 added to each of Δ_{A . . . D} becomes the low end and the previous upper limit stays the same.

In the example discussed above, with a negative result the boundaries become:

20,507<−U_{A}<=32,455

0<=U_{B}<=32,455

24,755<=U_{C}<=36,703

10,160<=U_{D}<=32,455

Then if the number of iterations is less than the value n, the processor repeats the set of calculations from steps 608 to 628 with the new values of U_{A . . . D} with the number of repetitions being equal to the binary logarithm of the initial aperture's diameter.

n=log₂(23,897)

In this case, 15 repetitions will be enough to focus the aperture on the target, giving us a cluster of four plot points.

At step 619, after n iterations of steps 608-628, the average of these points is used as the location of the source sound emitter, and the maximum difference between these points is the accuracy.

Accuracy and Calibration

Because the sounds that are received travel through the air, the speed of sound and the arrival times are affected by both air temperature and wind speed. By referencing local weather stations via an internet connection, we can determine the current conditions and modify the calculations accordingly. For example, for dry air at 1 atmosphere, the speed of sound (in meters/second) can be computed according to the equation:

cₐᵢᵣ=20.05*(t+273.15)^{1/2}

where cₐᵢᵣ is the speed of sound and t is the temperature in ° Celsius.

The method can also accommodate weather conditions using the calibration, collecting and recording observations at the time of calibration.

If an internet connection is unavailable or the system is located within an area that sees conditions significantly different than local weather stations (e.g. natural and man made ‘city’ canyons), a basic weather station can be installed with the system to obtain current weather conditions.

Accuracy, as measured against the distance between any pair of receivers, is offset by 1% for every seven MPH of wind or each temperature difference of 25° Fahrenheit.

System calibration is conducted through the process of determining the speed of sound at the installation location and is achieved by locating a speaker with each receiver/microphone. At the time of calibration, a specific tone is played sequentially through each speaker. The calibration sound's arrival at the microphone mounted by emitting speaker will mark the beginning of the test event, and the time it takes the sound to reach each of the other microphones will be compared to the already measured distance between microphones, providing a fresh calculation for the speed of sound to the other points in the semi-rectangular installation. Repeating this test for each speaker/microphone combination (n) provides a quantity of test points equal to

n²−n

For example, in an installation with four microphone/speakers the total number of test points would be 4²−4 or 12.

This calibration can be performed multiple times a day to account for changes in weather conditions that can affect the speed of sound.

Various embodiments of systems described herein can provide several advantages. The system described herein can be used for large outdoor areas with a high ambient noise level and a logarithmically high rate of target sounds.

Because the system uses Time Difference of Arrival, the receivers 120-123 can be mounted on vertical structures such as trees and utility poles, and are not required to be mounted to a physical barrier such as a wall. The system 100's target acquisition area is omnidirectional around the receiver/microphones 120-123 and can receive and locate targets in a fully three-dimensional space.

The system can specify accuracy at the time of any weather reading or calibration, and thus can determine when accuracy is degraded (e.g., if the sound wavelength is significantly different than the wavelength used to select the physical dimensions of the receiver array).

The system returns a location within a Cartesian coordinate system and, by including the location of cameras on those coordinates, a location relative to the cameras can be calculated for more precise localization and tracking. The cameras can then be directed manually or automatically toward the location of the sound. In some embodiments, the computed accuracy can be used to select the field of view (FOV) to ensure that the sound source is within the FOV. For example, when accuracy is determined to be degraded, a larger FOV can be used.

The system 100 uses a minimum of three, but typically four (and possibly more), microphones spread out to mark the boundaries of a rectangular area and uses a passive time difference of the signals' arrival to determine the sources' location. The area covered by The system 100 is approximately nine times larger than the microphones' rectangular boundaries.

The system uses a series of commercially-available and tunable filters to enhance audio from targeted noise sources and attenuate unwanted sounds. The filters can be tuned using High and Low pass band filters to narrow down the reception to the targeted frequency range.

The system 100 uses a novel means of calculating a source location based on the target's time difference of arrival at each receiver. The method, including Synthetic Aperture Passive Lateration (SAPL), achieves results similar to those achieved using Multilateration, but SAPL is less computationally intensive, and can be executed faster (by the same processor) or in the same amount of time (using a slower processor).

The system 100 continuously monitors the audio spectrum and maintains a running root mean square (average) of the current ambient sound level. The system 100 also maintains a configurable parameter for how much stronger a sound has to be (relative to background sounds and noise) before it triggers an event.

The system 100 takes each triggered event and assigns it to a small ‘slice of time’ based on the moment it was intercepted. This time slice is tunable and can be as small as the time it takes for a sound wave to cross the area being monitored. An area of forty thousand square feet would mean time slices of about 250 milliseconds. To account for possible time-slice overlaps (when a sound begins during one time slice and ends during the next time slice), the system 100 will check the previous time-slice for matched hits and SAPL will reject the target if the cross time-slice target doesn't actually fit with the previously received target.

A sound sample that begins the moment the sound level crosses the calculated level and ends after a configurable number of samples has been acquired, is translated into the frequency domain using a fast Fourier transform algorithm for identification. The system looks for signals in a specific range, but doesn't do this until a triggered event occurs, thus saving processing power.

The system calculates a running average on the source stream and the settings contain a value representing the audio decibels above ambient sound levels to determine if a possible target is detected.

When a triggered event occurs, the system 100 takes a small sample of the audio stream starting with the moment the volume exceeds the calculated threshold. The length of the sample is determined by a value in a configuration file and is measured in number of samples from the analog to digital converter.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

Although the subject matter has been described in terms of exemplary embodiments, it is not limited thereto. Rather, the appended claims should be construed broadly, to include other variants and embodiments, which may be made by those skilled in the art.

What is claimed is:

1. A system comprising:
at least three microphones for generating audio signals representing a sound generated by a sound source, each microphone having a respective identifier (ID);
a memory; and
a processor configured for:
identifying a respective set of strongest frequency components of the audio signals detected by each one of the at least three microphones;
generating a respective index from a time stamp indicating when the audio signals are received from each respective one of the at least three microphones and a respective plurality of frequency bands corresponding to the set of strongest frequency components;
storing records in the memory to be referenced using the indexes, each record containing the respective ID of one of the at least three microphones and a time when the sound is first detected by the microphone corresponding to the ID;
matching indexes of records from the memory corresponding to the sound for each of the at least three microphones; and
computing a location of the sound source based on the respective arrival times of the sound stored in the records having matching indices.

2. The system of claim 1, further comprising:
at least one analog filter coupled to receive the audio signals from each of the at least three microphones and to output filtered analog signals; and
at least one analog to digital converter for converting the filtered analog signals to digital signals, and providing the digital signals to the processor.

3. The system of claim 1, wherein the processor is configured to identify the set of strongest frequency components by:
performing fast Fourier transform of the digital signals to identify frequency components thereof; and
sorting the frequency components by strength.

4. The system of claim 1, wherein the processor is configured to form each respective index by concatenating: an ID of a time slice during which the sound is detected by one of the at least three microphones; and a plurality of frequency band IDs corresponding to the set of strongest frequency components sorted in descending order by signal strength.

5. The system of claim 4, wherein the processor is configured for matching indexes by finding two records having indexes comprising a same set of frequency band IDs and two identical or consecutive time slice IDs.

6. The system of claim 1, wherein the processor is configured to classify an audio signal as a target sound based on user input values specifying:
a number of consecutive samples in a set of audio signals to be analyzed to search for a target sound;
a minimum number of samples within the set of consecutive samples having a threshold signal strength for the target sound; and
a maximum number of samples within the set of consecutive samples having a threshold signal strength for the target sound.

7. The system of claim 6, wherein the processor is configured to classify the set of samples as noise if the set of samples has fewer than the minimum number of samples with the threshold signal strength for the target sound.

8. The system of claim 6, wherein the processor is configured to classify the set of samples as background sound if the set of samples has more than the maximum number of samples with the threshold signal strength for the target sound.

9. The system of claim 6, wherein the processor is configured to compute the threshold signal strength based on an average signal strength of the set of consecutive samples.

10. The system of claim 6, wherein the processor is configured to execute a determination of whether the set of sound signals corresponds to a target sound only if at least one sample has a threshold strength of at least the threshold signal strength.

11. The system of claim 1, wherein the processor is configured to compute the location by synthetic aperture passive lateration (SAPL).

12. The system of claim 11, wherein the processor performs SAPL by:
(a) computing a difference of time of arrival of the sound at each of the at least three microphones based on the respective records having a matching index;
(b) computing a respective range of possible travel times for the sound at each of the at least three microphones based on the respective difference of time of arrival of the sound at each of the at least three microphones;
(c) determining which of the at least three microphones has a smallest range of possible travel times for the sound; and
(d) adjusting each of the respective ranges of possible travel times based on the smallest range.

13. The system of claim 12, wherein the processor is configured to perform steps (b), (c) and (d) a number of times n, wherein n is given by:
n=log₂(initial synthetic aperture), and
the initial synthetic aperture is in a middle of the respective ranges computed the first time step (b) is performed.

14. A method of determining a location of a source of a sound using the system of claim 1.

15. Anon-transitory machine readable storage medium encoded with computer program code, such that when the computer program code is executed by a processor, the processor performs the method of claim 14.

16. A system comprising:
at least three microphones for generating audio signals representing a sound generated by a sound source, each microphone having a respective identifier (ID);
a memory; and
a processor configured for:
storing records in the memory to be referenced using indexes, the indexes based on a time stamp when the audio signals are generated and frequency components of the audio signals, each record containing the respective ID of one of the at least three microphones and a time when the sound is first detected by the microphone corresponding to the ID;
matching indexes of records from the memory corresponding to the sound for each of the at least three microphones; and
computing a location of the sound source based on the respective arrival times of the sound stored in the records having matching indices by synthetic aperture passive lateration (SAPL).

17. The system of claim 16, wherein the processor performs SAPL by:
(a) computing a difference of time of arrival of the sound at each of the at least three microphones based on the respective records having a matching index;
(b) computing a respective range of possible travel times for the sound at each of the at least three microphones based on the respective difference of time of arrival of the sound at each of the at least three microphones;
(c) determining which of the at least three microphones has a smallest range of possible travel times for the sound; and
(d) adjusting each of the respective ranges of possible travel times based on the smallest range.

18. The system of claim 17, wherein the processor is configured to perform steps (b), (c) and (d) a number of times n, wherein n is given by:
n=log₂(initial synthetic aperture), and
the initial synthetic aperture is a smallest one of the respective ranges computed the first time step (b) is performed.

19. The system of claim 16, wherein:
the processor is configured to classify an audio signal as a target sound based on user input values specifying:
a number of consecutive samples in a set of audio signals to be analyzed to search for a target sound;
a minimum number of samples within the set of consecutive samples having a threshold signal strength for the target sound; and
a maximum number of samples within the set of consecutive samples having a threshold signal strength for the target sound;
the processor is configured to classify the set of samples as noise if the set of samples has fewer than the minimum number of samples with the threshold signal strength for the target sound; and
the processor is configured to classify the set of samples as background sound if the set of samples has more than the maximum number of samples with the threshold signal strength for the target sound.

20. The system of claim 19, wherein the processor is configured to compute the threshold signal strength based on an average signal strength of the set of consecutive samples.
